(19) United States
(12) Patent Application Publication
(10) Pub. No.: US 2022/0018964 A1
(43) Pub. Date: Jan. 20, 2022

(54) SURROUNDINGS DETECTION DEVICE FOR VEHICLE

(71) Applicant: Toyota Jidosha Kabushiki Kaisha, Toyota-shi Aichi-ken (JP)

(72) Inventors: Kazuki Horiba, Shizuoka-ken (JP); Mitsuhiro Kinoshita, Mishima-shi (JP); Hiroki Saito, Shizuoka-ken (JP)

(73) Assignee: Toyota Jidosha Kabushiki Kaisha, Toyota-shi Aichi-ken (JP)

(21) Appl. No.: 17/375,457

(22) Filed: Jul. 14, 2021

(30) Foreign Application Priority Data
Jul. 20, 2020 (JP) 2020-124054

(51) Int. Cl. G01S 17/89; G01S 17/931; G01S 7/481; G01S 17/08; B60Q 1/24

(52) U.S. Cl. CPC G01S 17/89; G01S 17/931; B60Q 1/24; G01S 17/08; G01S 7/4817

(57) ABSTRACT

A surroundings detection device includes an infrared light projector, an infrared camera, and a processor. The infrared light projector is configured to output infrared light by switching between a uniform irradiation mode in which a predetermined range is irradiated with the infrared light, and a pattern irradiation mode in which the predetermined range is irradiated with the infrared light in a predetermined pattern. The processor is configured to: generate an image with brightness distribution for the predetermined range reflected by a target present in the predetermined range; and generate an image with pattern distribution for the predetermined range reflected by a target present in the predetermined range, and detect the distance to the target in the predetermined range based on the image with pattern distribution.

### CROSS-REFERENCE TO RELATED APPLICATION

This application claims priority to Japanese Patent Application No. 2020-124054 filed on Jul. 20, 2020, incorporated herein by reference in its entirety.

### BACKGROUND

### 1. Technical Field

The present disclosure relates to a device that detects the state of the surroundings of a vehicle such as an automobile. More particularly, the present disclosure relates to a device that detects a target such as an object in the surroundings of a vehicle using infrared light.

### 2. Description of Related Art

Infrared light is occasionally projected toward the surroundings of a vehicle to observe reflected light using an infrared camera etc. when there is not sufficient light in the surroundings, such as at night, to recognize and grasp the state of the surroundings of the vehicle, such as the presence or absence of a person, another vehicle, an obstacle, etc. and the position thereof, for example, for drive assist control, automatic drive control, etc. for the vehicle. Japanese Unexamined Patent Application Publication No. 2019-204988 (JP 2019-204988 A), for example, proposes a configuration in which infrared light is radiated toward the surroundings of a vehicle to capture an infrared image of the surroundings of the vehicle and recognize a target object in the image, and in which the brightness of a region with lower brightness is adjusted based on the brightness of a region in which the target object is present to improve the recognition performance in a region not irradiated with the infrared light. Japanese Unexamined Patent Application Publication No. 2019-125112 (JP 2019-125112 A) discloses a configuration in which a pattern of infrared light is projected forward of a vehicle to capture an image of the pattern, and geometric information on a region captured in the image is acquired using an active stereo method and used to estimate the position and the posture of the vehicle.

### SUMMARY

To recognize a moving object/road-side object in the surroundings of a vehicle using a camera image, for example, an in-vehicle fisheye camera etc. is used to capture an image of the front/side/rear of the vehicle, and a target object in the captured image is recognized using an image recognition technology that uses a deep learning algorithm such as semantic segmentation, to detect the position and the size of the target object and, further, detect the speed etc. from such information. When such an image processing and recognition technology are used, an image captured in a bright daytime environment and an image captured at night for a region irradiated by headlights are obtained under visible light with sufficient brightness. Thus, the recognition of a target object and the detection of the position, size, speed, etc. thereof described above can be achieved relatively precisely. In an environment in which an image cannot be obtained under visible light with sufficient brightness such as at night or in the shade, on the other hand, a range desired to be observed is irradiated with infrared light using a projector and an infrared image obtained with reflected light is used as described above, to recognize a target object and detect the position etc. thereof in a similar manner. In general, however, the performance of the recognition of a target object and the detection of the position etc. thereof and the precision of the recognition and detection results in the image processing and recognition technology which uses an image observed with infrared light are occasionally not good enough compared to the case where a visible light image is used, because of the low image sharpness, the low brightness, the unavailability of color information, etc. When a common in-vehicle infrared light projector is used to uniformly irradiate a range desired to be observed, the irradiation distance of infrared light is about several meters because of the hardware constraints such as mounting space, maximum output, and power consumption, and it is occasionally difficult to recognize a target object and detect the position etc. thereof to a sufficient degree in the entire distance range that the camera itself can recognize. Thus, the technology will be improved if the resolution in recognizing a target object and the resolution in detecting the position etc. thereof can be improved using the same infrared light projector, camera for detection, etc. in observing the surroundings of a vehicle using infrared light. In this respect, use of the active stereo method mentioned above enables detection of the distance from the vehicle to each point in a detected image, although it is difficult to grasp an image of the target object itself in the detected image. Thus, it is considered that the resolution in recognizing a target object and the resolution in detecting the position etc. thereof can be improved if information obtained using the active stereo method can be used in observing the surroundings of a vehicle using infrared light as described above.

The present disclosure provides a device that projects infrared light toward the surroundings of a vehicle and that observes the surroundings of the vehicle using an image obtained by capturing reflected light, in which the resolution in recognizing a target object and the resolution in detecting the position thereof are improved compared to the case where an observation range is simply uniformly irradiated with infrared light.

The present disclosure also provides a device that observes the surroundings of a vehicle using infrared light as described above, the device enabling detection of an infrared image of the surroundings of the vehicle and the distance to each point in the image using the same infrared light projector and camera for detection.

A first aspect of the present disclosure provides a surroundings detection device for a vehicle. The surroundings detection device includes: an infrared light projector configured to project infrared light toward a predetermined range around the vehicle; an infrared camera configured to capture an image of the predetermined range illuminated with the infrared light; and an image processing unit configured to process the image captured by the infrared camera. The infrared light projector includes: an infrared light source configured to emit the infrared light; and an infrared light output unit configured to output the infrared light by switching between a uniform irradiation mode in which the predetermined range is irradiated with the infrared light substantially uniformly, and a pattern irradiation mode in which the predetermined range is irradiated with the infrared light in a predetermined pattern. The image processing unit includes: a brightness distribution image generation unit configured to generate an image with brightness distribution for the predetermined range due to the infrared light reflected by a target that is present in the predetermined range, the image being obtained by the infrared camera, when the infrared light is projected toward the predetermined range in the uniform irradiation mode; and a distance measurement unit configured to generate an image with pattern distribution for the predetermined range due to the infrared light reflected by a target that is present in the predetermined range, the image with the brightness distribution being captured by the infrared camera, when the infrared light is projected from the infrared light output unit toward the predetermined range in the pattern irradiation mode, and configured to detect a distance to the target in the predetermined range based on the image with pattern distribution.

In the first aspect, the “predetermined range around the vehicle” toward which infrared light is projected may be a range set as desired, such as the front side, the right and left sides, and/or the rear side of the vehicle, and may be a range requested to be monitored for drive assist control or automatic drive control, for example. The “infrared light projector” may have an infrared light source and an infrared light output unit that implements the “uniform irradiation mode” and the “pattern irradiation mode” described above. The intensity, wavelength, etc. of the infrared light output from the infrared light source may be the same as those of infrared light output from an infrared light projector commonly used in this field. In the “uniform irradiation mode”, the predetermined range may be irradiated substantially uniformly. The phrase “substantially uniformly” may indicate a state in which the unevenness in the intensity of infrared light among irradiated locations is allowable in generating an image obtained by capturing the reflected infrared light. In the “pattern irradiation mode”, the predetermined range may be irradiated with infrared light in a predetermined pattern. Specifically, infrared light may be projected such that the intensity of the infrared light is high in the predetermined pattern which may be set as desired, such as spots, slits, a grid of dots, or a grid of slits, or such that the infrared light is propagated only in a pattern such as dots or slits, for example. The “infrared camera” may be a camera that is sensitive to infrared light and that can capture an infrared image, such as one commonly used in this field. The “image processing unit” may be implemented in any aspect, and may be a computer device, for example. The “brightness distribution image generation unit” and the “distance measurement unit” may be implemented by operation of the computer device according to a program. The “target” that is present in the predetermined range may be a person, a vehicle, an on-road or road-side object, an indication, a sign, etc. that can be detected in an image captured by the infrared camera through reflection of infrared light. The “image with brightness distribution” may be an image in which the brightness of each pixel in the image corresponds to the intensity of the reflected infrared light from the target, that is, an image obtained by capturing the target using infrared light in a normal aspect. On the other hand, the “image with pattern distribution” may be an image in which the brightness of each pixel in the image corresponds to the intensity of the reflected light from the target obtained when the target is irradiated with infrared light in the predetermined pattern as described above. The “image with pattern distribution” may be captured such that the pattern of infrared light radiated toward the surface of the target is deformed in an image from the infrared camera in accordance with a protrusion and a recess of the target.

In the first aspect, the infrared light projector is provided with an infrared light output unit, and infrared light is projected in a uniform irradiation mode in which the predetermined range is irradiated with the infrared light substantially uniformly, and a pattern irradiation mode in which the predetermined range is irradiated with the infrared light in a predetermined pattern. The infrared camera is configured to capture an image in which the predetermined range is illuminated with infrared light generally uniformly in the uniform irradiation mode, and capture an image in which the predetermined range is illuminated in the predetermined pattern in the pattern irradiation mode. While an infrared image in a normal aspect is obtained in the uniform irradiation mode, an infrared image in which the pattern is deformed in accordance with the distance to the target and the protrusion and recess of the target is obtained in the pattern irradiation mode. The distance to each point on the surface of the target is calculated from such deformation of the pattern, which makes it possible to obtain information on the distance to the target and the shape of the target, and which is also expected to improve the resolution in recognizing the target. With the first aspect described above, which can be implemented by a pair of an infrared light projector and an infrared camera, it is possible to acquire an infrared image for the entire predetermined range in the surroundings of the vehicle and, further, recognize information on the position, shape, etc. of the target more precisely, using the same infrared light projector and infrared camera.

In the first aspect, in the pattern irradiation mode, typically, the distance to the target in the predetermined range may be detected based on the image with pattern distribution using an active stereo method, for example. In that case, the distance to a reflection point on the target is calculated based on the parallax to the target between the infrared light projector and the infrared camera, more specifically using the angle of an infrared light beam projected from the infrared light projector, the angle of a reflection point on the target for the infrared light beam detected by the infrared camera, and the distance between the respective positions at which the infrared light projector and the infrared camera are disposed. Thus, the image processing unit may include a unit that performs such computation. A specific algorithm for the active stereo method may be configured as desired by a person skilled in the art.

In the first aspect, the uniform irradiation mode and the pattern irradiation mode may be executed alternately. Thus, the infrared light output unit may be configured to alternately switch between the uniform irradiation mode and the pattern irradiation mode. In the first aspect, the distance measurement unit may be configured to detect the distance to the target in the predetermined range based on the image with pattern distribution using an active stereo method. In the first aspect, the infrared light output unit may have a light beam control unit disposed between the infrared light source and an output port for the infrared light and configured to control a cross-sectional shape of a light beam of the infrared light, the light beam being propagated from the output port; and the light beam control unit may be configured to establish a first state in which the cross-sectional shape of the light beam is determined so as to become larger, or be diverged, as the light beam is propagated from the output port, establish a second state in which the cross-sectional shape of the light beam is determined so as to allow the light beam to pass through only a portion in a shape of the predetermined pattern in a plane in a cross-sectional direction of the light beam propagated from the output port, establish the first state in the uniform irradiation mode, and establish the second state in the pattern irradiation mode. In the first aspect, the light beam control unit may be a mirror device that uses a desired micro electro mechanical system (MEMS) technology (MEMS mirror device).

With the configuration described above, switching between the first state and the second state can be made immediately, and thus it is possible to immediately acquire an infrared image for the entire predetermined range in the surroundings of the vehicle and information on the position, shape, etc. of the target alternately.

In the first aspect, when detecting the distance to the target in the predetermined range in the surroundings of the vehicle in the pattern irradiation mode, such a distance is detectable if a bright point on the target at which infrared light is reflected can be detected using the infrared camera. Thus, in general, it is possible to detect the distance to a farther position than a position at which a clear image can be captured in the uniform irradiation mode. In particular, when the light beam control unit can make the brightness at a portion in the shape of the predetermined pattern relatively high in the pattern irradiation mode compared to the case where the predetermined range is irradiated uniformly in the uniform irradiation mode (the amount of light at each point on the target can be increased since an infrared light beam from the light source can be collected only at the portion in the shape of the predetermined pattern in the pattern irradiation mode, while the amount of light per unit area is reduced as the distance is longer since an infrared light beam from the light source is diverged in the uniform irradiation mode), the infrared camera can detect a bright point located farther than a position at which observation can be made in the uniform irradiation mode. Thus, the distance to the target can be detected beyond the range that an infrared light beam can reach in the uniform irradiation mode.

A second aspect of the present disclosure provides a surroundings detection device. The surroundings detection device includes: an infrared light projector configured to project infrared light toward a predetermined range in surroundings of a vehicle; an infrared camera configured to capture an image of the predetermined range illuminated with the infrared light; and a processor configured to process the image captured by the infrared camera. The infrared light projector includes an infrared light source and an infrared light output device. The infrared light source is configured to emit the infrared light. The infrared light output device is configured to output the infrared light by switching between a uniform irradiation mode, in which the predetermined range is irradiated with the infrared light substantially uniformly, and a pattern irradiation mode, in which the predetermined range is irradiated with the infrared light in a predetermined pattern. The processor is configured to: generate an image with brightness distribution for the predetermined range due to the infrared light reflected by a target that is present in the predetermined range, the image being obtained by the infrared camera, when the infrared light is projected toward the predetermined range in the uniform irradiation mode;

and generate an image with pattern distribution for the predetermined range due to the infrared light reflected by a target that is present in the predetermined range, the image being captured by the infrared camera, when the infrared light is projected from the infrared light output device toward the predetermined range in the pattern irradiation mode, and detect a distance to the target in the predetermined range based on the image with pattern distribution.

In the second aspect, the infrared light output device may be configured to alternately switch between the uniform irradiation mode and the pattern irradiation mode.

In the second aspect, the processor may be configured to detect the distance to the target in the predetermined range based on the image with pattern distribution using an active stereo method.

In the second aspect, the infrared light output device may have a controller disposed between the infrared light source and an output port for the infrared light and configured to control a cross-sectional shape of a light beam of the infrared light, the light beam being propagated from the output port. The controller may be configured to: establish a first state in which the cross-sectional shape of the light beam is determined so as to become larger as the light beam is propagated from the output port; establish a second state in which the cross-sectional shape of the light beam is determined so as to allow the light beam to pass through only a portion in a shape of the predetermined pattern in a plane in a cross-sectional direction of the light beam propagated from the output port; establish the first state in the uniform irradiation mode; and establish the second state in the pattern irradiation mode.

In the second aspect, the controller may be a micro electro mechanical system (MEMS) mirror device.

With the first and second aspects of the present disclosure, the device which observes the surroundings of the vehicle using an image obtained by projecting infrared light in the surroundings of the vehicle and capturing reflected light can obtain not only an infrared image for the entire predetermined range in the surroundings of the vehicle but also information on the position, shape, etc. of the target which is present in the predetermined range more precisely using a pair of an infrared light projector and an infrared camera. Since only a pair of an infrared light projector and an infrared camera is required for a certain predetermined range, it is expected that a space required for the devices should be reduced, the number of components should be reduced, and the cost should be reduced, compared to the case where a device for obtaining an infrared image for the entire range and a device for obtaining information on the position, shape, etc. of the target are prepared separately. In addition, information on the image of the target in the infrared image for the entire range and the information on the position, shape, etc. of the target may be combined with each other to be used to obtain a more precise recognition result for the target. With the first aspect of the present disclosure, it is expected that observation should be made precisely compared to the device which observes the surroundings of the vehicle using an image obtained by projecting infrared light toward the surroundings of the vehicle and capturing reflected light. Thus, the first aspect of the present disclosure may be advantageously adopted in order to grasp the state of the surroundings of the vehicle in an environment at night or at low illuminance in drive assist control or automatic drive control for the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram of a vehicle on which a surroundings detection device for a vehicle according to an embodiment of the present disclosure is mounted;

FIG. 1B is a block diagram illustrating the configuration of the surroundings detection device for a vehicle according to the embodiment of the present disclosure;

FIG. 2A schematically illustrates an aspect of control for an infrared light beam from an infrared light projector of the surroundings detection device for a vehicle according to the present embodiment, illustrating a state in which infrared light is projected in a uniform irradiation mode;

FIG. 2B schematically illustrates an aspect of control for an infrared light beam from the infrared light projector of the surroundings detection device for a vehicle according to the present embodiment, illustrating a state in which infrared light is projected in a pattern irradiation mode;

FIG. 3A schematically illustrates a state in which an overall image of a target is captured on a light reception surface of an infrared camera when infrared light is projected in the uniform irradiation mode;

FIG. 3B schematically illustrates a state in which spots of infrared light are captured on the light reception surface of the infrared camera when infrared light is projected in the pattern irradiation mode;

FIG. 3C illustrates a process of detecting the distance to a target on which spots of infrared light are observed using the active stereo method in the pattern irradiation mode; and

FIG. 4 is a flowchart illustrating operation of the surroundings detection device for a vehicle according to the present embodiment.

### DETAILED DESCRIPTION OF EMBODIMENTS

### Device Configuration

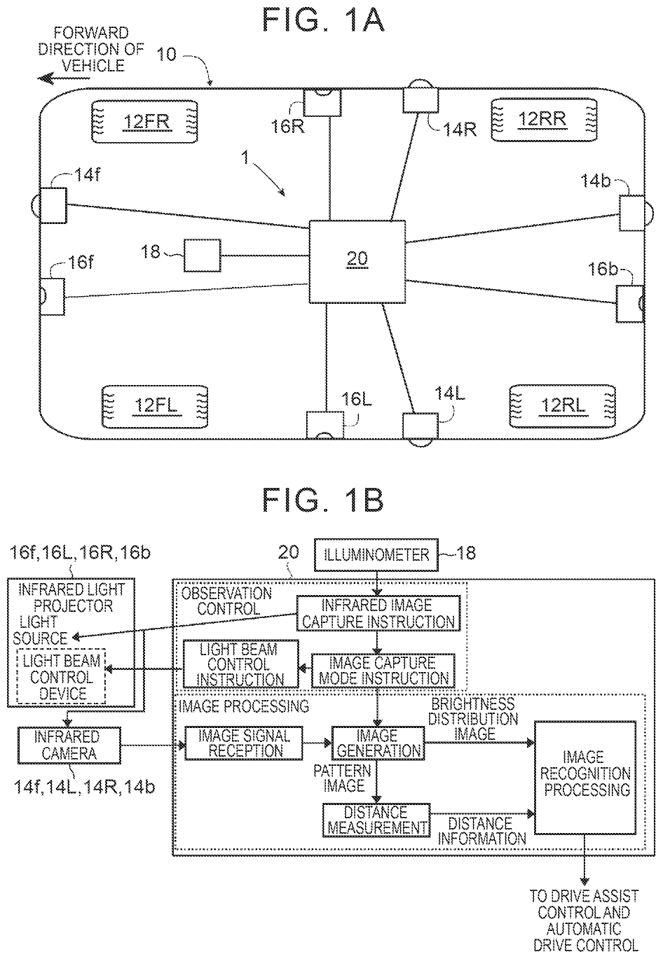

With reference to FIG. 1A, a surroundings detection device 1 for a vehicle according to the present embodiment is mounted on a vehicle 10 such as an automobile that has right and left front wheels 12FR, 12FL and right and left rear wheels 12RR, 12RL. In the surroundings detection device 1 for a vehicle according to the present embodiment, infrared cameras 14f, 14L, 14R, 14b and infrared light projectors 16f, 16L, 16R, 16b may be combined with each other and provided on corresponding surfaces of the vehicle 10, in order to observe the front side, the right and left sides, and the rear side, respectively, of the vehicle 10 using infrared light. An electronic control device 20 is provided to execute control for operation of the infrared cameras 14f to 14b and the infrared light projectors 16f to 16b and processing of images captured by the infrared cameras 14f to 14b. In addition, the vehicle 10 may be provided with an illuminometer 18 that detects the illuminance of the surroundings of the vehicle 10 so that a detected illuminance value is input to the electronic control device 20.

In the configuration described above, the infrared cameras 14f, 14L, 14R, 14b may be image capture cameras that are sensitive to infrared light and that are commonly used in this field. In particular, the cameras may be fisheye cameras that collect light from the surroundings through a fisheye lens and form an image, in order to capture an image for a wider range.

The infrared light projectors 16f to 16b have a light source that emits infrared light and that is commonly used in this field, a light beam control device that controls the cross-sectional shape of an infrared light beam, and an output port that outputs the infrared light beam with the controlled cross-sectional shape. The light source may be a light emitting diode (LED) light source, a laser light source, etc. that are commonly used in this field to emit infrared light. The wavelength of the infrared light may be a wavelength that is commonly used to capture infrared images. The light beam control device is a device configured to implement a uniform irradiation mode, in which infrared light is projected so as to illuminate an observation range generally uniformly, and a pattern irradiation mode, in which infrared light is projected toward the observation range as pattern light, the cross section of which has a predetermined pattern shape, as described in detail later. Such a light beam control device may be implemented using a mirror device that uses a desired micro electro mechanical system (MEMS) technology (MEMS mirror device), for example.

The electronic control device 20 described above may be implemented by a computer, and may include a computer that has a central processing unit (CPU), a read only memory (ROM), a random access memory (RAM), and input/output port devices of a common type connected to each other by a bidirectional common bus, and a drive circuit. The configuration and operation of various sections of the electronic control device 20 to be described below may be implemented through operation of the computer performed in accordance with a program.

With reference to FIG. 1B, generally speaking, the electronic control device 20 is composed of an observation control portion that controls operation of the infrared light projectors 16f to 16b and the infrared cameras 14f to 14b, and an image processing portion that executes processing of images obtained from the infrared cameras 14f to 14b. The observation control portion may be provided with an infrared image capture instruction unit, an image capture mode instruction unit, and a light beam control instruction unit. The image processing portion may be provided with an image signal reception unit, an image generation unit, a distance measurement unit, and an image recognition processing unit. More particularly, in the observation control portion, the infrared image capture instruction unit is configured to receive an illuminance value of the surroundings of the vehicle detected by the illuminometer 18, and provide an instruction to execute infrared image capture to each of the infrared light projectors 16f to 16b and the infrared cameras 14f to 14b when the illuminance value falls below a predetermined value (visible light recognizable illuminance). The image capture mode instruction unit is configured to determine the infrared image capture mode as one of the uniform irradiation mode and the pattern irradiation mode, as described later, in response to the instruction for infrared image capture, and provide an instruction for the determined image capture mode to the light beam control instruction unit and the image generation unit of the image processing portion. The light beam control instruction unit is configured to provide a control instruction to the light beam control device of the infrared light projectors in accordance with the instruction for the image capture mode from the image capture mode instruction unit, and control the state of the light beam control device. In the image processing portion, meanwhile, the image generation unit is configured to generate image data from brightness signals from the infrared cameras 14f to 14b received by the image signal reception unit. The image generation unit generates a brightness distribution image (normal infrared image) constituted with a brightness distribution in the captured range when the image capture mode is the uniform irradiation mode, and generates a pattern image, that is, an image in which significant brightness is given to only pixels corresponding to an image of a portion exposed to an infrared light beam radiated in a predetermined pattern, as described later, when the image capture mode is the pattern irradiation mode, in accordance with the instruction for the image capture mode from the image capture mode instruction unit. The distance measurement unit is configured to calculate the distance to a target in the captured range in accordance with the active stereo method, as described later, using the pattern image. The image recognition unit may reference the brightness distribution image which is generated by the image generation unit and the distance information on the target in the captured range, the distance information being obtained by the distance measurement unit, to recognize the target in the image in various aspects. Then, the image recognition unit may send the recognition result to a corresponding control device in order to use the recognition result for the drive assist control or the automatic drive control.

### Device Operation

### (1) Overview

Generally speaking, the surroundings detection device for a vehicle according to the present embodiment, which uses infrared light, is a device that uses an infrared image capture technology and that detects the state of the surroundings of the vehicle when the illuminance of the surroundings of the vehicle is low, such as at night, by projecting infrared light toward a range to be observed and capturing an image of the surroundings due to reflected light using infrared cameras. In such an infrared image capture technology, the performance of the recognition of a target object and the detection of the position etc. thereof and the precision of the recognition and detection results in the image processing and recognition technology which uses an observed image are occasionally not good enough compared to the case where a visible light image is used. When a common in-vehicle infrared light projector is used to uniformly irradiate a range desired to be observed, the irradiation distance of infrared light is about several meters, and it is occasionally not possible to recognize a target object and detect the position etc. thereof to a sufficient degree in the entire distance range that the camera itself can recognize. One reason is that, when an observation range is uniformly irradiated by an infrared light projector, an infrared light beam is output as divergent light, the intensity of irradiation with the output infrared light beam per unit area is reduced as the distance to an output port is longer, and the reflected light from the target may not have sufficient intensity.

Thus, in the present embodiment, it is attempted to output an infrared light beam in a predetermined pattern from the infrared light projectors to capture an image of a portion of a target in an observation range irradiated with the infrared light beam in the predetermined pattern using the infrared cameras, and calculate the distance to the target which reflects the infrared light beam using the active stereo method based on the parallax between the infrared light projectors and the infrared cameras so that the obtained distance information can be used to detect and recognize the surroundings of the vehicle, along with an aspect in which an infrared light beam is radiated uniformly from the infrared light projectors to capture images of the surroundings of the vehicle. In the configuration according to the present embodiment, the in-vehicle infrared light projectors are each configured to adopt, in addition to a common light source, a light beam control device that is realized by switching between the uniform irradiation mode and the pattern irradiation mode, and the infrared cameras are each a common camera. Thus, information such as the position of the target and the protrusion and recess of the target can be obtained from the information on the distance to the target in the observation range, in addition to common infrared images, which is expected to contribute to improving the precision in detecting and recognizing the surroundings of the vehicle.

### (2) Image Capture Mode

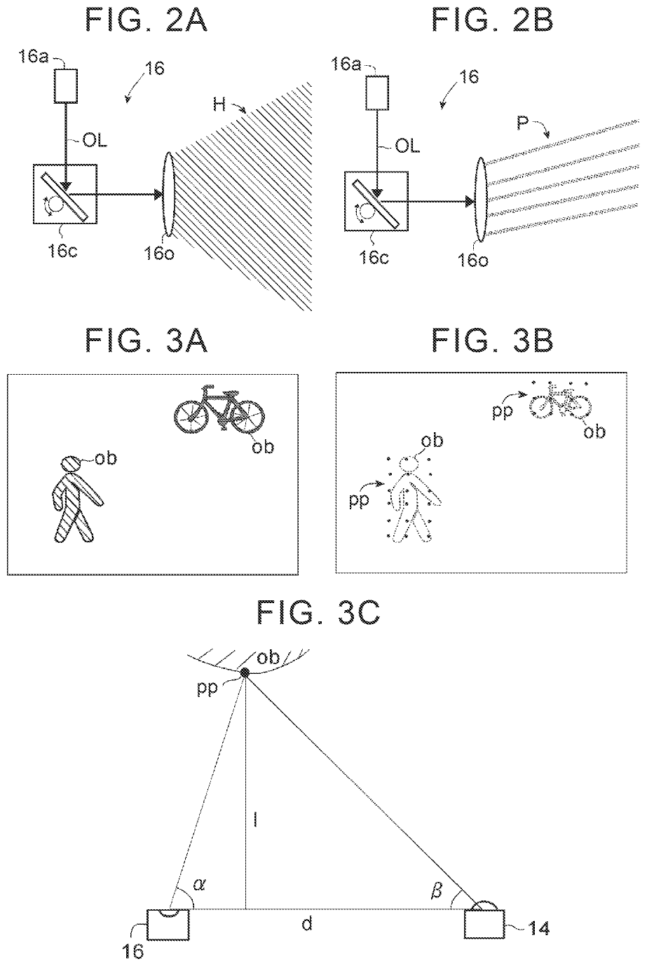

As described above, the device according to the present embodiment executes, as image capture modes, two modes, namely the uniform irradiation mode, in which infrared light is projected from the projector so as to illuminate the observation range generally uniformly, and the pattern irradiation mode, in which infrared light is projected from the projector so as to irradiate the observation range with an infrared light beam in a predetermined pattern. Switching between such modes is achieved, as schematically depicted in FIGS. 2A and 2B, by a light beam control device 16c controlling, as appropriate, the cross-sectional shape of an infrared light beam from a light source 16a of the infrared light projector such that an infrared light beam is output from an output port 16o in a desired aspect. On the other hand, it is only necessary that the infrared camera should detect the brightness of light that reaches each pixel on a light reception surface in either mode, and the infrared camera may operate in the same manner irrespective of the mode.

### (a) Uniform Irradiation Mode

In the uniform irradiation mode, with reference to FIG. 2A, the cross-sectional shape of an infrared light beam OL from the light source 16a of the infrared light projector is adjusted by the light beam control device 16c such that an infrared light beam output from the output port 16o is formed into divergent light H spread generally uniformly in the entire observation range. Specifically, the infrared light beam in the shape of the divergent light H can be formed by optically expanding the cross section of the infrared light beam OL from the light source 16a of the infrared light projector, or scanning the entire observation range with a thin infrared light beam OL at a high speed, using the light beam control device 16c. In the uniform irradiation mode, an image with sufficient brightness cannot be captured with the amount of light per unit area reduced when the entire observation range is too wide. Thus, the size of the observation range may be adjusted such that appropriate brightness can be obtained.

Then, in the uniform irradiation mode, the infrared camera captures an image of targets in the surroundings of the vehicle illuminated generally uniformly with infrared light, and the image generation unit generates an image with brightness distribution that matches the intensity of reflected infrared light for the entire surface of targets ob in the observation range, that is, a normal infrared image, as schematically depicted in FIG. 3A, using a brightness signal transmitted from the infrared camera. When a normal amount of infrared light is projected, an image of targets in the range of several meters from the vehicle can be recognized in the image.

### (b) Pattern Irradiation Mode

In the pattern irradiation mode, as schematically depicted in FIG. 2B, the cross-sectional shape of the infrared light beam OL from the light source 16a of the infrared light projector is adjusted by the light beam control device 16c such that an infrared light beam output from the output port 16o is formed into pattern light P that irradiates only a part of the observation range in the shape of a predetermined pattern. The infrared light beam in the shape of the pattern light P can be formed by deforming or adjusting the cross section of the infrared light beam OL from the light source 16a of the infrared light projector into the shape of the predetermined pattern, such as spots, slits, a grid of dots, or a grid of slits, or scanning the observation range with a thin infrared light beam OL at a high speed such that the observation range is irradiated in the shape of the predetermined pattern, using the light beam control device 16c.

Then, in the pattern irradiation mode, the infrared camera captures an image in which only a portion of a target in the observation range exposed to the infrared light beam in the shape of the predetermined pattern, has significant brightness. The image generation unit generates a pattern image in which a significant brightness value is given to pixels corresponding to only a portion of the surfaces of targets ob in the observation range exposed to an infrared light beam pp in the shape of the predetermined pattern, as schematically depicted in FIG. 3B, using a brightness signal transmitted from the infrared camera.

Regarding the generated pattern image, when the infrared light projector and the infrared camera are away in position from each other in a configuration in which the infrared camera captures an image of reflection points of an infrared light beam in a predetermined pattern projected from the infrared light projector, there is a parallax to the reflection points of the infrared light beam between the infrared light projector and the infrared camera. Thus, the positions of images of points (spots) pp in the pattern image exposed to the pattern light of the infrared light beam, are varied in accordance with the distance from the vehicle to the points. Thus, it is possible to detect the distance from the surface of the vehicle (a surface on which the infrared light projector and the infrared camera are installed) to the points pp in the pattern of the infrared light beam based on the parallax (active stereo method). Specifically, as schematically depicted in FIG. 3C, a distance 1 to a certain point pp on a target ob exposed to a spot of an infrared light beam, is given by

1=d(1/tanα+1/tanβ) . . . (1)

where d is the distance between the infrared light projector 16 and the infrared camera 14 and α is an angle formed between a line that connects the infrared light projector 16 and the infrared camera 14 and a direction from the infrared light projector 16 to the point pp, and β is an angle formed between a line that connects the infrared light projector 16 and the infrared camera 14 and a direction from the infrared camera 14 to the point pp. The angles α and β for each point of spots of an infrared light beam captured in the pattern image can be determined based on the angle of a light beam output from the infrared light projector and the position of an image of the point in the pattern image. Thus, the distance to each point of the spots of the infrared light beam captured in the pattern image can be calculated using such angles, and consequently the position of the target ob in the observation range, or further the shape of the target ob, can be detected. The detected distance information may be represented as a distance distribution image in which a distance is given to each pixel of the image, for example.

The range in which a distance is detectable in the pattern irradiation mode is expected to be longer than the observable range in the uniform irradiation mode, which is several meters. For example, when an infrared light beam is projected in the pattern irradiation mode, the infrared light beam is radiated locally, and thus the light intensity at points irradiated with the infrared light beam can be relatively high compared to the uniform irradiation mode, depending on the aspect of control for the cross-sectional shape of the light beam by the light beam control device. In that case, an infrared light beam with higher intensity reaches farther to make it possible to capture images of reflection points of the infrared light beam on a target located at a farther position, and thus it is expected to be possible to detect the distance to the target at the farther position. Even if the light intensity at points irradiated with an infrared light beam is not varied compared to the uniform irradiation mode, it is only necessary that only the positions of reflection points of the infrared light beam on a target can be detected in the image in the pattern irradiation mode, and the positions of such reflection points are detected without image sharpness (contrast in brightness), which is required to recognize an image of the target in the image in the uniform irradiation mode. Thus, it is expected to be possible to detect a target at a farther position than the position of a target that can be recognized in the uniform irradiation mode.

As described above, the brightness distribution image for the observation range formed with infrared light and obtained in the uniform irradiation mode and the information on the distance to a target in the observation range obtained in the pattern irradiation mode may be used by the image recognition unit to recognize the target in the image in various aspects, as discussed in relation to the description of FIG. 1B. In particular, the information on the distance to a target in the observation range obtained in the pattern irradiation mode is expected to make it possible to recognize a target located at a distance at which the target cannot be recognized in the brightness distribution image in the uniform irradiation mode.

### (3) Processing Procedure

As discussed already, the surroundings detection device for a vehicle according to the present embodiment executes observation of the surroundings of the vehicle using infrared light when the illuminance value of the surroundings of the vehicle measured by the illuminometer falls below a predetermined value. In such observation, the uniform irradiation mode may be executed, and thereafter the pattern irradiation mode may be executed with the light beam control device switched.

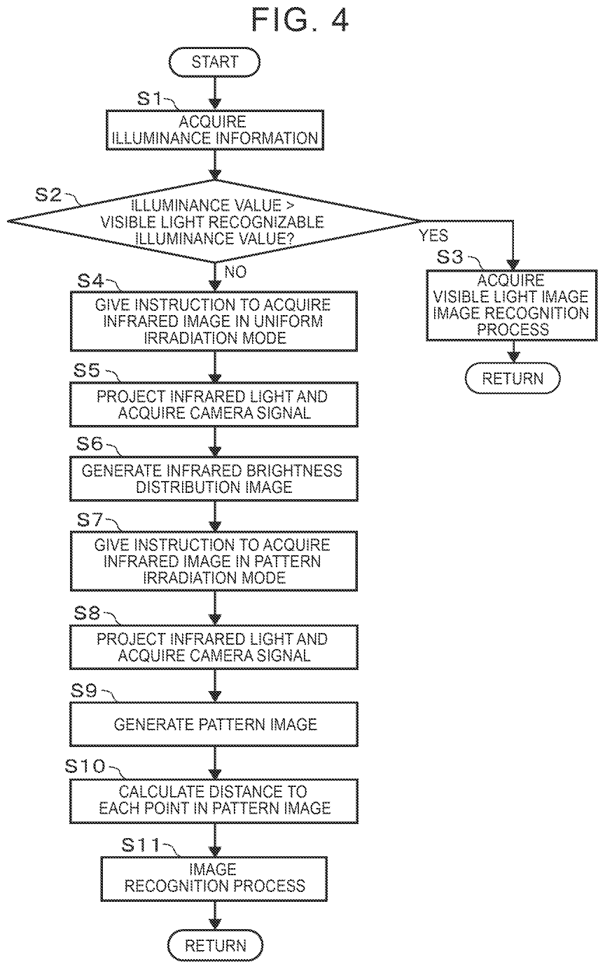

In a specific processing procedure by the device, with reference to the flowchart in FIG. 4, an illuminance value of the surroundings of the vehicle is first acquired from the illuminometer (step 1), and it is determined whether the illuminance value exceeds a visible light recognizable illuminance value (step 2). The visible light recognizable illuminance is the minimum illuminance required to recognize a target in a camera image captured using visible light. When the illuminance value of the surroundings of the vehicle exceeds the visible light recognizable illuminance value, a camera image captured in an environment under visible light outside the vehicle is acquired, and a target in the image may be recognized (step 3).

When the illuminance value of the surroundings of the vehicle falls below the visible light recognizable illuminance value, on the other hand, observation of the surroundings of the vehicle with infrared light is selected, and an instruction to acquire an infrared image in the uniform irradiation mode is first given (step 4). Consequently, the light beam control device is controlled to a state (first state) in which infrared light is projected in the uniform irradiation mode. In this state, infrared light is projected toward the observation range in the surroundings of the vehicle, and an image of the observation range is captured using the infrared camera (step 5). The observation range may include the front side, the right and left sides, and the rear side of the vehicle. In that case, a control instruction is sent to the infrared light projectors 16f to 16b and the infrared cameras 14f to 14b. When the front side of the vehicle is illuminated by headlights, observation can be performed under visible light. Thus, in that case, it is only necessary that the observation range for infrared light should include the right and left sides and the rear side of the vehicle, and an instruction to acquire an infrared image may be provided to the infrared light projectors 16R, 16L, and 16b and the infrared cameras 14R, 14L, and 14b. The infrared cameras transmit the brightness of each pixel on the light reception surface to the image processing unit as a camera signal, and the image generation unit generates an image with brightness distribution for the entire observation range, that is, a normal infrared image (step 6; the image generation unit functions as the brightness distribution image generation unit).

When an infrared image is acquired in the uniform irradiation mode as described above, an instruction is given to acquire an infrared image in the pattern irradiation mode (step 7). Consequently, the light beam control device is controlled to a state (second state) in which infrared light is projected in the pattern irradiation mode. In this state, infrared light is projected toward the observation range in the surroundings of the vehicle, and an image of the observation range is captured using the infrared camera (step 8). Also in this mode, the observation range may include the front side, the right and left sides, and the rear side of the vehicle. In that case, a control instruction is sent to the infrared light projectors 16f to 16b and the infrared cameras 14f to 14b. When the front side of the vehicle is illuminated by headlights, observation can be performed under visible light. Thus, in that case, it is only necessary that the observation range for infrared light should include the right and left sides and the rear side of the vehicle, and an instruction to acquire an infrared image may be provided to the infrared light projectors 16R, 16L, and 16b and the infrared cameras 14R, 14L, and 14b. The infrared cameras transmit the brightness of each pixel on the light reception surface to the image processing unit as a camera signal, and the image generation unit generates a pattern image for the observation range as described above (step 9). After that, the distance measurement unit calculates the distance to reflection points of the infrared light beam on a target in the observation range using such a pattern image (step 10). Specifically, for example, the output angle (α in FIG. 3C) of an infrared light beam in a predetermined pattern projected toward the observation range is recorded, the angle of incidence (β in FIG. 3C) of images of reflection points of the infrared light beam in the pattern image to the camera is determined based on the respective positions of the images of the corresponding reflection points (the position of each pixel corresponds to the angle of the direction of the image), and the distance to the reflection points of the infrared light beam on the target in the observation range may be calculated based on the output angle, the incident angle, and the distance between the projector and the camera using the formula (1).

When the image with brightness distribution for the entire observation range and the information on the distance to the target in the observation range are obtained, the image recognition/processing unit may recognize the target in the observation range in any aspect using such image and information (step 11). Then, the recognition result may be used for drive assist control and automatic drive control for the vehicle.

It should be understood, for the surroundings detection device for a vehicle according to the present embodiment described above, that it is not necessary to separately prepare an infrared light projector and an infrared camera to capture an image with brightness distribution for the entire observation range and a pattern image for acquiring information on the distance to a target in the observation range, and that such images can be captured using the same infrared light projector and infrared camera by switching between the states of the light beam control device. With such a configuration, the dimensions of the device can be suppressed to be relatively small, and a reduction in the cost is also expected. In addition, the device according to the present embodiment is advantageous in that information on the distance to a target in the observation range can be obtained easily compared to the case of observation performed using a normal infrared image. In some cases, the distance to a target in the observation range can also be detected from a normal infrared image using machine learning such as deep learning and a complicated analysis method. In such cases, in general, the computation load may be high, and the time and the cost required for the computation may be increased. In the case of the present embodiment, on the other hand, the process required for the distance measurement in the pattern irradiation mode is relatively easy, is achieved with a low load, and consequently is expected to suppress the computation time and cost required for the distance measurement. That is, it is easy to acquire data in which information on the distance to a target is added to a normal infrared image.

The above description, which is made in association with the embodiment of the present disclosure, can be modified and changed easily in many ways by a person skilled in the art. It would be clear that the present disclosure is not limited to the exemplary embodiment described above, and that the present disclosure is applicable to a variety of devices without departing from the concept of the present disclosure.

What is claimed is:

1. A surroundings detection device for a vehicle, the surroundings detection device comprising:
an infrared light projector configured to project infrared light toward a predetermined range around the vehicle;
an infrared camera configured to capture an image of the predetermined range illuminated with the infrared light; and
an image processing unit configured to process the image captured by the infrared camera, wherein
the infrared light projector includes an infrared light source and an infrared light output unit,
the infrared light source is configured to emit the infrared light,
the infrared light output unit is configured to output the infrared light by switching between a uniform irradiation mode in which the predetermined range is irradiated with the infrared light substantially uniformly, and a pattern irradiation mode in which the predetermined range is irradiated with the infrared light in a predetermined pattern,
the image processing unit includes a brightness distribution image generation unit and a distance measurement unit,
the brightness distribution image generation unit is configured to, when the infrared light is projected toward the predetermined range in the uniform irradiation mode, generate an image with brightness distribution for the predetermined range due to the infrared light reflected by a target that is present in the predetermined range, the image with the brightness distribution being obtained by the infrared camera, and
the distance measurement unit is configured to, when the infrared light is projected from the infrared light output unit toward the predetermined range in the pattern irradiation mode,
generate an image with pattern distribution for the predetermined range due to the infrared light reflected by a target that is present in the predetermined range, the image with the pattern distribution being captured by the infrared camera, and
detect a distance to the target in the predetermined range based on the image with the pattern distribution.

2. The surroundings detection device according to claim 1, wherein the infrared light output unit is configured to alternately switch between the uniform irradiation mode and the pattern irradiation mode.

3. The surroundings detection device according to claim 1, wherein the distance measurement unit is configured to detect the distance to the target in the predetermined range based on the image with the pattern distribution by using an active stereo method.

4. The surroundings detection device according to claim 1, wherein:
the infrared light output unit has a light beam control unit disposed between the infrared light source and an output port for the infrared light and the light beam control unit is configured to control a cross-sectional shape of a light beam of the infrared light, the light beam being propagated from the output port; and
the light beam control unit is configured to
establish a first state in which the cross-sectional shape of the light beam is determined so as to become larger as the light beam is propagated from the output port,
establish a second state in which the cross-sectional shape of the light beam is determined so as to allow the light beam to pass through only a portion in a shape of the predetermined pattern in a plane in a cross-sectional direction of the light beam propagated from the output port, and
establish the first state in the uniform irradiation mode, and establish the second state in the pattern irradiation mode.

5. The surroundings detection device according to claim 4, wherein the light beam control unit is a MEMS mirror device.

6. A surroundings detection device comprising:
an infrared light projector configured to project infrared light toward a predetermined range around a vehicle;
an infrared camera configured to capture an image of the predetermined range illuminated with the infrared light; and
a processor configured to process the image captured by the infrared camera, wherein
the infrared light projector includes an infrared light source and an infrared light output device,
the infrared light source is configured to emit the infrared light,
the infrared light output device is configured to output the infrared light by switching between a uniform irradiation mode in which the predetermined range is irradiated with the infrared light substantially uniformly, and a pattern irradiation mode in which the predetermined range is irradiated with the infrared light in a predetermined pattern,
the processor is configured to
when the infrared light is projected toward the predetermined range in the uniform irradiation mode, generate an image with brightness distribution for the predetermined range due to the infrared light reflected by a target that is present in the predetermined range, the image with the brightness distribution being obtained by the infrared camera, and
when the infrared light is projected from the infrared light output device toward the predetermined range in the pattern irradiation mode, generate an image with pattern distribution for the predetermined range due to the infrared light reflected by a target that is present in the predetermined range, the image being captured by the infrared camera, and detect a distance to the target in the predetermined range based on the image with the pattern distribution.

7. The surroundings detection device according to claim 6, wherein the infrared light output device is configured to alternately switch between the uniform irradiation mode and the pattern irradiation mode.

8. The surroundings detection device according to claim 6, wherein the processor is configured to detect the distance to the target in the predetermined range based on the image with the pattern distribution by using an active stereo method.

9. The surroundings detection device according to claim 6, wherein:
the infrared light output device has a controller disposed between the infrared light source and an output port for the infrared light and the controller is configured to control a cross-sectional shape of a light beam of the infrared light, the light beam being propagated from the output port; and
the controller is configured to
establish a first state in which the cross-sectional shape of the light beam is determined so as to become larger as the light beam is propagated from the output port,
establish a second state in which the cross-sectional shape of the light beam is determined so as to allow the light beam to pass through only a portion in a shape of the predetermined pattern in a plane in a cross-sectional direction of the light beam propagated from the output port,
establish the first state in the uniform irradiation mode, and
establish the second state in the pattern irradiation mode.

10. The surroundings detection device according to claim 9, wherein the controller is a MEMS mirror device.
